(19) United States
(12) Patent Application Publication
(10) Pub. No.: US 2007/0130354 A1
(43) Pub. Date: Jun. 7, 2007

(54) Distributed Server Network

(75) Inventors: Christopher James NASON, Kanata, ON (CA); Paul PROVENCAL, Gatineau (CA); Robert STAR, Kanata, ON (CA)

Correspondence Address: WILLIAM J. SAPONE;COLEMAN SUDOL SAPONE P.C., 714 COLORADO AVENUE, BRIDGE PORT, CT, 06605, US

(73) Assignee: Mitel Networks Corporation, Ottawa (CA)

(21) Appl. No.: 11/563,231

(22) Filed: Nov. 27, 2006

(30) Foreign Application Priority Data
Dec. 2, 2005 (EP) 05257443.1

(51) Int. Cl. G06F 15/16

(52) U.S. Cl. 709/230

(57) ABSTRACT

A method for providing a distributed TFTP server network among a plurality of IP devices, said method including providing a plurality of IP devices in communication with a central TFTP server, each IP device maintaining a list of available servers with the central TFTP server being at the bottom the list, each IP device selecting and attempting to connect to the TFTP server at the top of the list of available servers, downloading software from the TFTP server and sending a server ready signal over the distributed TFTP server network following successful download, the IP device then being added to the top of the list of available servers and operating as a TFTP server to allow software download to other IP devices in the distributed TFTP server network.

### FIELD OF THE INVENTION

The present invention relates to communication systems, in particular, to a distributed TFTP server network for downloading software to a plurality of devices connected to the network.

### BACKGROUND OF THE INVENTION

In medium size and large businesses, communication between devices is typically established over a network, such as a LAN or a WAN, for example. In order to communicate over the network, devices such as IP phones, computers, or other network devices must be assigned an IP address. This is normally accomplished by the device requesting an IP address from a server using Dynamic Host Configuration Protocol (DHCP). In addition, when the device is first connected to the network or when software upgrades are required, devices such as IP phones customarily incorporate a TFTP client in order to download software, including executable binary files, from a central TFTP server, such as a PBX. TFTP (Trivial File Transfer Protocol) is a simple file transfer protocol used for downloading bootcode to diskless devices, such as IP phones. TFTP is set forth in RFC 1350 published by the Network Working Group in July 1992.

However, the PBX is only able to perform a limited number of concurrent TFTP sessions because each TFTP session between a phone client and the PBX burdens the processing capability of the PBX.

The size of the downloaded executable binary files has grown from approximately 256 KB to approximately 4 MB and continues to grow. At the same time, the size of PBXs continues to grow, with increasing numbers of phones. The large size of the executable binary files and the increased number of phones connected to the PBX compromises the performance of the PBX. Bandwidth utilization and upgrade time for all connected phones is also impacted.

Many PBX configurations include remote campuses routed over T1 links and other bandwidth limited media to a central TFTP server. IP fragmentation in routed networks and narrow communication connections results in TFTP download times becoming onerous. In addition, the processing capability of the PBX is impacted by phones performing DHCP, attempting to make TCP connections or attempting SSL or other secure protocols on top of TCP.

It is therefore desirable to improve TFTP download time from a PBX to multiple IP phones, and otherwise reduce the processing burden on the PBX.

### SUMMARY OF THE INVENTION

In one aspect of the present invention there is provided a method for providing a distributed TFTP server network among a plurality of IP devices, the method including:

providing a plurality of IP devices, each of the IP devices being in communication with a central TFTP server;

each IP device maintaining a list of available servers, the central TFTP server remaining at the bottom of the list of available servers;

at least one IP device selecting a TFTP server from the top of the list of available servers and attempting to connect to the TFTP server;

downloading software from the TFTP server to the at least one IP device;

the at least one IP device sending a server ready signal over the distributed TFTP server network following successful download of the software whereupon the at least one IP device is added to the top of the list of available servers and operates as a further TFTP server for allowing other IP devices in the distributed TFTP server network to attempt to connect to the further TFTP server for downloading the software.

The distributed TFTP method of the present invention reduces the number of TFTP clients that the central TFTP server (i.e. PBX) must service. Further, the distributed TFTP method reduces the number of router hops and possible MTU (Maximum Transmission Unit) fragmentation between the TFTP servers and TFTP clients. Additionally, TFTP traffic over the external communication links of remote campuses will also be reduced.

### BRIEF DESCRIPTION OF THE DRAWINGS

The invention will be better understood with reference to the following Figures in which like numerals denote like parts and in which:

FIG. 1 is a schematic view of an exemplary PBX network;

FIG. 2 is a schematic view showing communication among phones within the PBX network of FIG. 1 for establishing a distributed TFTP network according to the present invention; and

FIG. 3 is a timing diagram showing operation of the distributed TFTP network of FIG. 2.

### DETAILED DESCRIPTION OF THE PREFERRED EMBODIMENTS

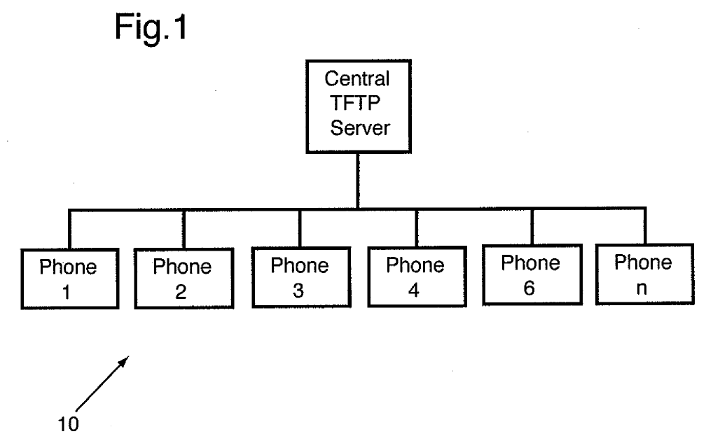

Referring to FIG. 1, a schematic overview of a PBX network 10 is generally shown. The network 10 includes a central TFTP server and a plurality of IP phones. The phones are linked to the central TFTP server via a local area network (LAN) in a manner that is well known in the art. The phones may alternatively be linked to the TFTP server via a wireless connection or any medium that supports a TCP/IP network.

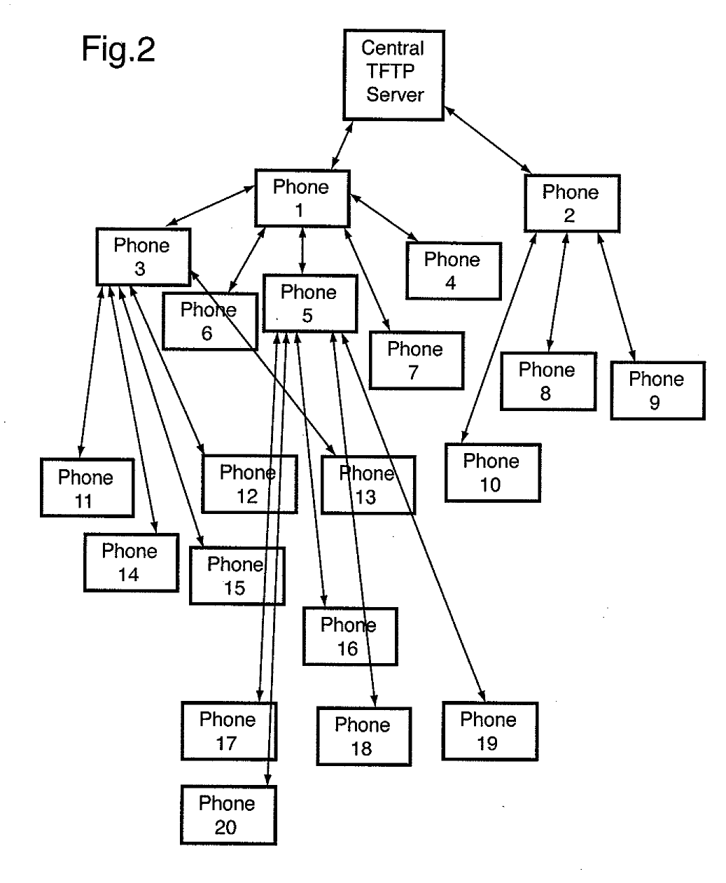

Each phone contains a TFTP client that has the ability to transform itself into a TFTP server. As such, a phone may download software from the central TFTP server or, alternatively, may download software from another phone that has transformed itself into a TFTP server. An example of a distributed TFTP method is shown in FIG. 2 in which phones 1, 2, 3 and 5 have transformed into TFTP servers in order to service other phones. Once a phone has downloaded the software from the central TFTP server or another phone, it can transform itself into a TFTP server. As such, the number of TFTP servers that are available to the network 10 grows over time.

Each phone is provided with two IP addresses. The first IP address is the central TFTP server IP address. The second IP address is used to allow the phones to communicate with one another and may be either a multicast group address or a broadcast address. The TFTP sessions between the phones and the central TFTP server are unicast. Similarly, the TFTP sessions between the phones and a phone that has transformed itself into a TFTP server are also unicast. The phones only use multicasts or broadcasts to communicate server status with one another.

The phones determine that the distributed TFTP method is being used by the network 10 from the DHCP options or from manual entry, i.e. because there are two TFTP IP addresses. The phones know that they are to attempt the distributed TFTP method if one of the TFTP addresses provided to them is a multicast or broadcast IP address. Such addresses can be identified because they fall in the range of 224.0.0.0 to 239.255.255.255. If the phones detect a TFTP IP address in this range, they determine that the distributed TFTP method is being used.

In the distributed TFTP method, each phone institutes a random back off prior to attempting TFTP. All phones must observe and complete a random back off before attempting to initiate a TFTP session.

When a phone completes a TFTP download, it transmits a “TFTP Server Ready” message using the designated communication protocol dictated by DHCP or manual entry. The information that is transmitted with the “TFTP Server Ready” message includes: set type, filename available, file revision number, phone IP address and phone MAC address. Each time a phone in a random back off state reads a “TFTP Server Ready” message with a corresponding set type and filename, it adds the TFTP server to it's TFTP server list. Each new TFTP server is added to the top of the list. The central TFTP server, which the phone discovers via DHCP or manual entry, remains at the bottom of the list.

When searching for a TFTP server, phones start at the top of their TFTP server list and continue down the list until an available TFTP server is found. Phones that are in TFTP server mode service five TFTP sessions, either sequentially or concurrently. Additional TFTP session requests are answered with a TFTP error message. If a phone is rejected, the phone then attempts a TFTP session with the next TFTP server on it's TFTP server list. Phones that are in TFTP server mode resume normal operation if they have completed five TFTP session requests or if they have completed less than 5 TFTP session requests and more than 10 seconds has elapsed since their last TFTP session request. Once a phone has resumed normal operation, further TFTP requests from other phones are denied.

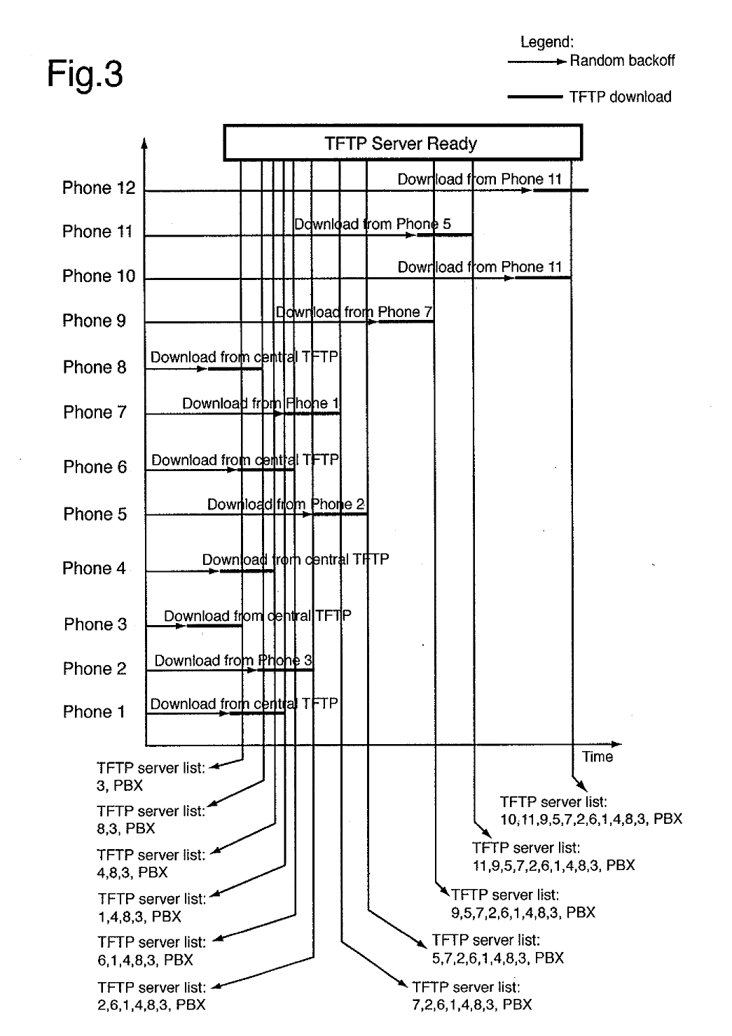

FIG. 3 shows a chart of a distributed TFTP phone scheme. As shown, the phone with the shortest random back off (phone 3 in FIG. 3) is generally the first to initiate and complete a TFTP session with the central TFTP server. For phone 3, the sequence of events is as follows. Initially, phone 3's TFTP server list is populated by a single IP address, the central TFTP server. Phone 3 then initiates a TFTP session with the central TFTP server. Once the TFTP session is complete, phone 3 sends the “TFTP Server Ready” message to the local area network. Other phones that are just completing their random back off and require the same software filename, add the new TFTP server (phone 3) to the top of the their TFTP server list. The other phones then initiate TFTP sessions with the new TFTP server.

In the scenario depicted in FIG. 3, phone 3 downloads software to a single phone (phone 2) rather than the maximum permitted 5 phones. This is because by the time the next phone (phone 7) requests a TFTP session, additional phones (phone 8 and phone 4) have completed their TFTP sessions and been added to the top of the available server list. Therefore, following the software download to phone 2, phone 3 resumes normal operation and denies further TFTP requests from other phones 10 seconds after the TFTP session request from phone 2.

In another embodiment, the phones 14 are used to download software for other IP phones or to download the software to devices other than IP phones, such as personal digital assistants (PDAs), faxes and printers, for example. In order to download software to devices other than IP phones, the phones are programmed to download binaries meant for other devices. The phones 14 would have to modify the information in their broadcasts accordingly.

A specific embodiment of the present invention has been shown and described herein. However, modifications and variations may occur to those skilled in the art. All such modifications and variations are believed to be within the sphere and scope of the present invention.

What is claimed is:

1. A method for providing a distributed TFTP server network among a plurality of IP devices, said method comprising:
providing said plurality of IP devices, each of said IP devices being in communication with a central TFTP server;
each IP device maintaining a list of available servers, said central TFTP server remaining at the bottom of said list of available servers;
at least one IP device selecting a TFTP server from the top of said list of available servers and attempting to connect to said TFTP server;
downloading software from said TFTP server to said at least one IP device;
said at least one IP device sending a server ready signal over said distributed TFTP server network following successful download of said software whereupon said at least one IP device is added to the top of said list of available servers and operates as a further TFTP server for allowing other IP devices in said distributed TFTP server network to attempt to connect to said further TFTP server for downloading said software.

2. A method as claimed in claim 1, wherein each of said IP devices waits a random back off period following power up and prior to attempting to connect to either said TFTP server or said further TFTP server.

3. A method as claimed in claim 2, wherein said IP device having the shortest random back off period connects to the central TFTP server.

4. A method as claimed in claim 1, wherein said IP device is an IP phone.

5. An IP device for use in a distributed TFTP server network in which a plurality of IP devices communicate with a central TFTP server, said IP device comprising:
a TFTP client for communicating with a TFTP server;
means for maintaining a list of available servers including said central TFTP server, said central TFTP server remaining bottom-most on said list of available servers;
means for downloading software from said TFTP server; and
means for sending a signal to said plurality of IP devices after said IP device has successfully downloaded software from said TFTP server, said IP device being added top-most on said list of available servers and said IP device, whereby said IP device operates as a further TFTP server for allowing other IP devices in said distributed TFTP server network to attempt to connect to said further TFTP server for downloading said software.

6. An IP device as claimed in claim 5, wherein said IP device is an IP phone.
